(19) United States
(12) Patent Application Publication
(10) Pub. No.: US 2026/0122629 A1
(43) Pub. Date: Apr. 30, 2026

(54) DYNAMIC SWITCHING FOR SEMI-PERSISTENT SCHEDULING AND CONFIGURED GRANT

(71) Applicant: QUALCOMM INCORPORATED, San Diego, CA (US)

(72) Inventors: Fang Yuan, Beijing (CN); Iyab Issam Sakhnini, San Diego, CA (US); Tao Luo, San Diego, CA (US)

(21) Appl. No.: 18/865,656

(22) PCT Filed: Aug. 2, 2022
(86) PCT No.: PCT/CN2022/109627

§ 371 Date: Nov. 13, 2024

(51) Int. Cl. H04W 72/11; H04L 1/00; H04W 72/044; H04W 72/20

(52) U.S. Cl. CPC H04W 72/11; H04L 1/0003; H04W 72/044; H04W 72/20

(57) ABSTRACT

Methods, systems, and devices for wireless communications are described. A user equipment (UE) may receive a message indicating multiple parameter sets for uplink or downlink semi-persistent scheduling and communicate in accordance with a first parameter set. The UE may receive a control message indicating to deactivate the first parameter set and activate a second parameter set. For example, the control message may indicate to switch from a first semi-persistent scheduling configuration to a second semi-persistent scheduling configuration. The UE may deactivate the first parameter set and activate the second parameter set based on the control message. The UE may communicate in accordance with the second parameter set based on the control message.

### CROSS REFERENCE

The present Application is a 371 national stage filing of International PCT Application No. PCT/CN2022/109627 by Yuan et al. entitled “DYNAMIC SWITCHING FOR SEMI-PERSISTENT SCHEDULING AND CONFIGURED GRANT,” filed Aug. 2, 2022, which is assigned to the assignee hereof, and which is expressly incorporated by reference in its entirety herein.

### FIELD OF TECHNOLOGY

The following relates to wireless communications, including dynamic switching for semi-persistent scheduling and configured grant.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support dynamic switching for semi-persistent scheduling and configured grant. For example, the described techniques provide for a network entity to transmit, and a user equipment (UE) to receive, a control message that switches a semi-persistent scheduling configuration (e.g., for uplink or downlink) at the UE. The UE may receive a message indicating multiple parameter sets for uplink or downlink semi-persistent scheduling and communicate in accordance with a first parameter set. The UE may receive a control message indicating to deactivate the first parameter set and activate a second parameter set. For example, the control message may indicate to switch from a first semi-persistent scheduling configuration to a second semi-persistent scheduling configuration. The UE may deactivate the first parameter set and activate the second parameter set based on the control message. The UE may communicate in accordance with the second parameter set based on the control message. In some examples, the UE may be configured with a switching list, or a mapping between indexes and pairs of parameter sets. For example, the control message may include an index associated with a pair of parameter sets, indicating to switch from a first parameter set to a second parameter set (e.g., deactivating the first parameter set and activating the second parameter set).

A method for wireless communications at a UE is described. The method may include receiving a message indicating a set of multiple parameter sets for semi-persistent scheduling, communicating in accordance with a first parameter set of the set of multiple parameter sets, receiving a control message indicating to deactivate the first parameter set and activate a second parameter set of the set of multiple parameter sets, deactivating the first parameter set based on the control message, and communicating in accordance with the second parameter set based on the control message.

An apparatus for wireless communications at a UE is described. The apparatus may include a processor, memory coupled with the processor, and instructions stored in the memory. The instructions may be executable by the processor to cause the apparatus to receive a message indicating a set of multiple parameter sets for semi-persistent scheduling, communicate in accordance with a first parameter set of the set of multiple parameter sets, receive a control message indicating to deactivate the first parameter set and activate a second parameter set of the set of multiple parameter sets, deactivate the first parameter set based on the control message, and communicate in accordance with the second parameter set based on the control message.

Another apparatus for wireless communications at a UE is described. The apparatus may include means for receiving a message indicating a set of multiple parameter sets for semi-persistent scheduling, means for communicating in accordance with a first parameter set of the set of multiple parameter sets, means for receiving a control message indicating to deactivate the first parameter set and activate a second parameter set of the set of multiple parameter sets, means for deactivating the first parameter set based on the control message, and means for communicating in accordance with the second parameter set based on the control message.

A non-transitory computer-readable medium storing code for wireless communications at a UE is described. The code may include instructions executable by a processor to receive a message indicating a set of multiple parameter sets for semi-persistent scheduling, communicate in accordance with a first parameter set of the set of multiple parameter sets, receive a control message indicating to deactivate the first parameter set and activate a second parameter set of the set of multiple parameter sets, deactivate the first parameter set based on the control message, and communicate in accordance with the second parameter set based on the control message.

In some examples of the method, apparatuses, and non-transitory computer-readable medium described herein, receiving the control message may include operations, features, means, or instructions for receiving the control message indicating one or more parameters for the second parameter set, where communicating in accordance with the second parameter set may be based on the one or more parameters for the second parameter set.

In some examples of the method, apparatuses, and non-transitory computer-readable medium described herein, the one or more parameters include a modulation and coding scheme, a time domain resource allocation, a frequency domain resource allocation, one or more transmission configuration indicator states, or any combination thereof.

In some examples of the method, apparatuses, and non-transitory computer-readable medium described herein, receiving the message may include operations, features, means, or instructions for receiving an indication of an association between one or more indexes and one or more pairings of the set of multiple parameter sets.

In some examples of the method, apparatuses, and non-transitory computer-readable medium described herein, the message indicates an index associated with deactivating the first parameter set and activating the second parameter set.

In some examples of the method, apparatuses, and non-transitory computer-readable medium described herein, the message includes a second one or more indexes associated with activating a corresponding parameter set of the set of multiple parameter sets.

In some examples of the method, apparatuses, and non-transitory computer-readable medium described herein, the one or more indexes may be one or more hybrid automatic repeat request process identifiers.

In some examples of the method, apparatuses, and non-transitory computer-readable medium described herein, communicating in accordance with the second parameter set may include operations, features, means, or instructions for activating the second parameter set based on the control message.

In some examples of the method, apparatuses, and non-transitory computer-readable medium described herein, receiving the message may include operations, features, means, or instructions for receiving the message indicating a set of multiple downlink semi-persistent scheduling parameter sets, where communicating in accordance with the first parameter set includes receiving on a first set of semi-persistent scheduling resources according to a first downlink semi-persistent scheduling parameter set of the set of multiple downlink semi-persistent scheduling parameter sets, and where communicating in accordance with the second parameter set includes receiving on a second set of semi-persistent scheduling resources according to a second downlink semi-persistent scheduling parameter set of the set of multiple downlink semi-persistent scheduling parameter sets.

In some examples of the method, apparatuses, and non-transitory computer-readable medium described herein, receiving the message may include operations, features, means, or instructions for receiving the message indicating a set of multiple configured grant parameter sets, where communicating in accordance with the first parameter set includes transmitting on a first set of configured grant resources according to a first configured grant parameter set of the set of multiple configured grant parameter sets, and where communicating in accordance with the second parameter set includes transmitting on a second set of configured grant resources according to a second configured grant parameter set of the set of multiple configured grant parameter sets.

In some examples of the method, apparatuses, and non-transitory computer-readable medium described herein, receiving the message may include operations, features, means, or instructions for receiving a radio resource control message indicating the set of multiple parameter sets for semi-persistent scheduling.

In some examples of the method, apparatuses, and non-transitory computer-readable medium described herein, the set of multiple parameter sets for semi-persistent scheduling includes a set of multiple downlink semi-persistent scheduling parameter sets or a set of multiple configured grant parameter sets, or both.

A method for wireless communications at a network entity is described. The method may include transmitting a message indicating a set of multiple parameter sets for semi-persistent scheduling, communicating in accordance with a first parameter set of the set of multiple parameter sets, transmitting a control message indicating to deactivate the first parameter set and activate a second parameter set of the set of multiple parameter sets, and communicating in accordance with the second parameter set based on the control message.

An apparatus for wireless communications at a network entity is described. The apparatus may include a processor, memory coupled with the processor, and instructions stored in the memory. The instructions may be executable by the processor to cause the apparatus to transmit a message indicating a set of multiple parameter sets for semi-persistent scheduling, communicate in accordance with a first parameter set of the set of multiple parameter sets, transmit a control message indicating to deactivate the first parameter set and activate a second parameter set of the set of multiple parameter sets, and communicate in accordance with the second parameter set based on the control message.

Another apparatus for wireless communications at a network entity is described. The apparatus may include means for transmitting a message indicating a set of multiple parameter sets for semi-persistent scheduling, means for communicating in accordance with a first parameter set of the set of multiple parameter sets, means for transmitting a control message indicating to deactivate the first parameter set and activate a second parameter set of the set of multiple parameter sets, and means for communicating in accordance with the second parameter set based on the control message.

A non-transitory computer-readable medium storing code for wireless communications at a network entity is described. The code may include instructions executable by a processor to transmit a message indicating a set of multiple parameter sets for semi-persistent scheduling, communicate in accordance with a first parameter set of the set of multiple parameter sets, transmit a control message indicating to deactivate the first parameter set and activate a second parameter set of the set of multiple parameter sets, and communicate in accordance with the second parameter set based on the control message.

In some examples of the method, apparatuses, and non-transitory computer-readable medium described herein, transmitting the control message may include operations, features, means, or instructions for transmitting the control message indicating one or more parameters for the second parameter set, where communicating in accordance with the second parameter set may be based on the one or more parameters for the second parameter set.

In some examples of the method, apparatuses, and non-transitory computer-readable medium described herein, the one or more parameters include a modulation and coding scheme, a time domain resource allocation, a frequency domain resource allocation, one or more transmission configuration indicator states, or any combination thereof.

In some examples of the method, apparatuses, and non-transitory computer-readable medium described herein, transmitting the message may include operations, features, means, or instructions for transmitting an indication of an association between one or more indexes and one or more pairings of the set of multiple parameter sets.

In some examples of the method, apparatuses, and non-transitory computer-readable medium described herein, the message indicates an index associated with deactivating the first parameter set and activating the second parameter set.

In some examples of the method, apparatuses, and non-transitory computer-readable medium described herein, the message includes a second one or more indexes associated with activating a corresponding parameter set of the set of multiple parameter sets.

In some examples of the method, apparatuses, and non-transitory computer-readable medium described herein, the one or more indexes may be one or more hybrid automatic repeat request process identifiers.

In some examples of the method, apparatuses, and non-transitory computer-readable medium described herein, transmitting the message may include operations, features, means, or instructions for transmitting the message indicating a set of multiple downlink semi-persistent scheduling parameter sets, where communicating in accordance with the first parameter set includes transmitting on a first set of semi-persistent scheduling resources according to a first downlink semi-persistent scheduling parameter set of the set of multiple downlink semi-persistent scheduling parameter sets, and where communicating in accordance with the second parameter set includes transmitting on a second set of semi-persistent scheduling resources according to a second downlink semi-persistent scheduling parameter set of the set of multiple downlink semi-persistent scheduling parameter sets.

In some examples of the method, apparatuses, and non-transitory computer-readable medium described herein, transmitting the message may include operations, features, means, or instructions for transmitting the message indicating a set of multiple configured grant parameter sets, where communicating in accordance with the first parameter set includes receiving on a first set of configured grant resources according to a first configured grant parameter set of the set of multiple configured grant parameter sets, and where communicating in accordance with the second parameter set includes receiving on a second set of configured grant resources according to a second configured grant parameter set of the set of multiple configured grant parameter sets.

In some examples of the method, apparatuses, and non-transitory computer-readable medium described herein, transmitting the message may include operations, features, means, or instructions for transmitting a radio resource control message indicating the set of multiple parameter sets for semi-persistent scheduling.

In some examples of the method, apparatuses, and non-transitory computer-readable medium described herein, the set of multiple parameter sets for semi-persistent scheduling includes a set of multiple downlink semi-persistent scheduling parameter sets or a set of multiple configured grant parameter sets, or both.

### BRIEF DESCRIPTION OF THE DRAWINGS

FIG. 1 illustrates an example of a wireless communications system that supports dynamic switching for semi-persistent scheduling (SPS) and configured grant in accordance with one or more aspects of the present disclosure.

FIG. 2 illustrates an example of a wireless communications system that supports dynamic switching for SPS and configured grant in accordance with one or more aspects of the present disclosure.

FIG. 3 illustrates an example of a process flow that supports dynamic switching for SPS and configured grant in accordance with one or more aspects of the present disclosure.

FIGS. 4 and 5 show block diagrams of devices that support dynamic switching for SPS and configured grant in accordance with one or more aspects of the present disclosure.

FIG. 6 shows a block diagram of a communications manager that supports dynamic switching for SPS and configured grant in accordance with one or more aspects of the present disclosure.

FIG. 7 shows a diagram of a system including a device that supports dynamic switching for SPS and configured grant in accordance with one or more aspects of the present disclosure.

FIGS. 8 and 9 show block diagrams of devices that support dynamic switching for SPS and configured grant in accordance with one or more aspects of the present disclosure.

FIG. 10 shows a block diagram of a communications manager that supports dynamic switching for SPS and configured grant in accordance with one or more aspects of the present disclosure.

FIG. 11 shows a diagram of a system including a device that supports dynamic switching for SPS and configured grant in accordance with one or more aspects of the present disclosure.

FIGS. 12 through 14 show flowcharts illustrating methods that support dynamic switching for SPS and configured grant in accordance with one or more aspects of the present disclosure.

### DETAILED DESCRIPTION

A wireless communications system may support communications with traffic bursts, where an amount of signaling on a channel can vary greatly at different periods of time. For example, in extended reality (XR), traffic bursts may be periodically or semi-persistently scheduled, with some jitter or variedness in transmission time. In some cases, a quantity of packets or packet size, or both, may vary between traffic bursts. In some systems, XR signaling may be scheduled via semi-persistently scheduled communications, such as semi-persistent scheduling (SPS) for downlink transmissions or a configured grant for uplink transmissions. However, an arrival time of XR traffic may vary, occurring at non-integer periodicities of time, such as arriving before or after an SPS occasion or a configured grant occasion.

To improve power savings due to traffic bursts, a network entity may configure a user equipment (UE) with a different semi-persistently scheduled configuration with one or more updated parameters. For example, the network entity may configure the UE with a semi-persistently scheduled configuration that has a longer or shorter timer length, thereby increasing or decreasing the duration between occasions for semi-persistently scheduled communications at the UE. In some systems, the network entity may transmit a first control message to deactivate a first semi-persistently scheduled configuration (e.g., SPS or configured grant) and transmit a second control message to activate a second semi-persistently scheduled configuration with different parameters. However, transmitting two separate control messages to update the parameters of a semi-persistently scheduled configuration may result in significant overhead and delay for implementing the updated semi-persistently scheduled configuration.

The techniques described herein provide techniques for updating parameters of a semi-persistently scheduled configuration using a single control message. For example, a network entity may transmit a control message to a UE which both deactivates a first semi-persistently scheduled configuration and activates a second semi-persistently scheduled configuration. In some cases, the UE may be configured with a mapping between identifiers and switches between semi-persistently scheduled configurations. For example, the control message may include a first identifier, which may indicate for the UE to switch from a first semi-persistently scheduled configuration to a second semi-persistently scheduled configuration. These techniques may provide dynamic switching between semi-persistently scheduled configurations at a UE for both uplink (e.g., configured grant) and downlink (e.g., SPS).

Aspects of the disclosure are initially described in the context of wireless communications systems. Aspects of the disclosure are further illustrated by and described with reference to apparatus diagrams, system diagrams, and flowcharts that relate to dynamic switching for SPS and configured grant.

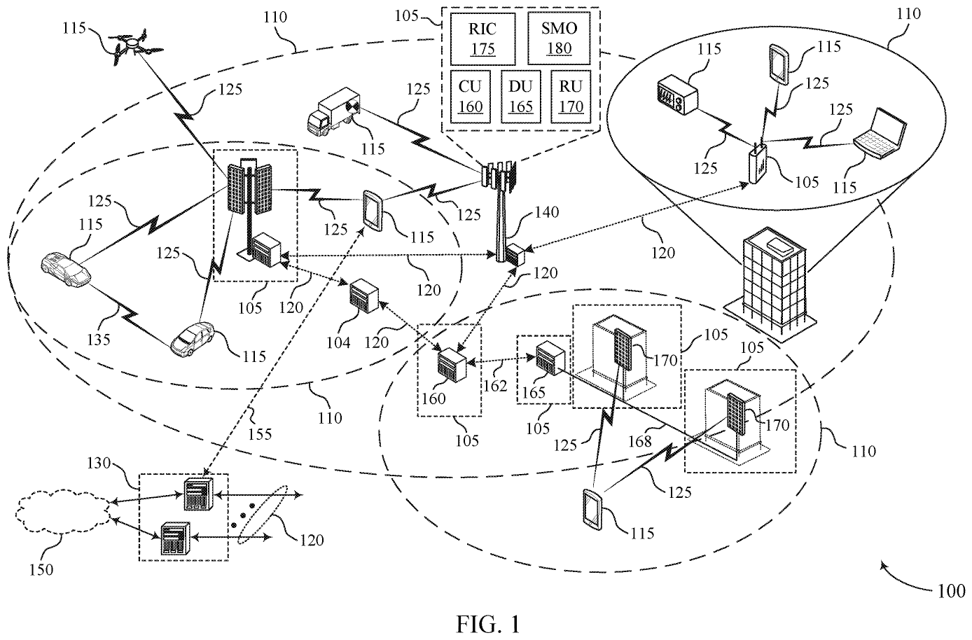

FIG. 1 illustrates an example of a wireless communications system 100 that supports dynamic switching for SPS and configured grant in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support dynamic switching for SPS and configured grant as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support semi-persistent or semi-persistently scheduled communications. For example, a network entity 105 may configure a UE 115 for downlink semi-persistently scheduled signaling or uplink semi-persistently scheduled signaling. In some examples, an SPS configuration may be an example of a configuration for downlink semi-persistently scheduled signaling, and a configured grant may be an example of a configuration for uplink semi-persistently scheduled signaling. Semi-persistent scheduling may refer to downlink SPS or uplink semi-persistent scheduling, or both.

The wireless communications system 100 may support communications with traffic bursts, where an amount of signaling on a channel can vary greatly at different periods of time. For example, in XR, traffic bursts may be periodically or semi-persistently scheduled, with some jitter or variedness in transmission time. For example, XR signaling may be scheduled for 16.67 ms periods or 8.33 ms periods. For example, XR signaling may be scheduled via semi-persistently scheduled communications, such as an SPS configuration for downlink transmissions or a configured grant for uplink transmissions. However, an arrival time of XR traffic may vary, occurring at non-integer periodicities of time, such as arriving before or after an SPS occasion or a configured grant occasion. For example, XR traffic may arrive (e.g., be available to be transmitted or received or be transmitted or received) at times which are not aligned with the periodicity. That is, an XR traffic burst may occur before or after an edge of a semi-persistently scheduled resource occasion. In some cases, the traffic may have a jitter of around 4 ms. In some cases, a quantity of packets or packet size, or both, may vary between traffic bursts.

To improve power savings due to traffic bursts, a network entity 105 may configure a UE 115 with a different semi-persistently scheduled configuration with one or more updated parameters. For example, the network entity 105 may configure the UE 115 with a semi-persistently scheduled configuration that has a longer or shorter timer length, thereby increasing or decreasing the duration between occasions for semi-persistently scheduled communications at the UE 115.

In some systems, the network entity 105 may transmit a first control message to deactivate a first semi-persistently scheduled configuration (e.g., SPS or configured grant) and transmit a second control message to activate a second semi-persistently scheduled configuration with different parameters. However, transmitting two separate control messages to update the parameters of a semi-persistently scheduled configuration may result in significant overhead and delay for implementing the updated semi-persistently scheduled configuration.

The wireless communications system 100, and wireless communications systems described herein, may support techniques for updating parameters of a semi-persistently scheduled configuration using a single control message. For example, a network entity 105 may transmit a control message to a UE 115 which both deactivates a first semi-persistently scheduled configuration and activates a second semi-persistently scheduled configuration. In some cases, the UE 115 may be configured with a mapping between identifiers and switches between semi-persistently scheduled configurations. For example, the control message may include a first identifier, which may indicate for the UE 115 to switch from a first semi-persistently scheduled configuration to a second semi-persistently scheduled configuration. These techniques may provide dynamic switching between semi-persistently scheduled configurations at a UE 115 for both uplink (e.g., configured grant) and downlink (e.g., SPS).

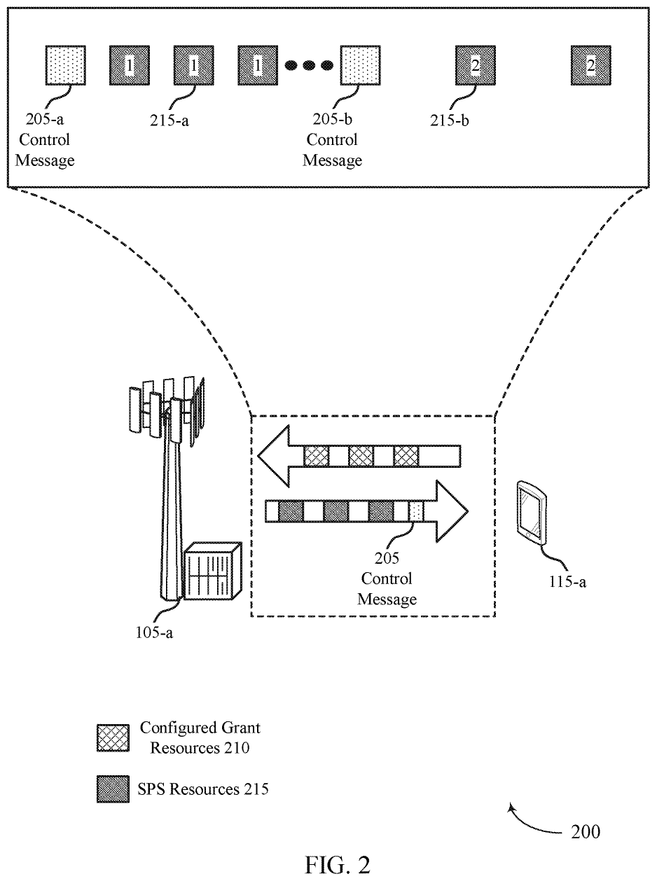

FIG. 2 illustrates an example of a wireless communications system 200 that supports dynamic switching for SPS and configured grant in accordance with one or more aspects of the present disclosure. The wireless communications system 200 may include a UE 115-a and a network entity 105-a, which may be respective examples of a UE 115 and a network entity 105 as described with reference to FIG. 1.

The network entity 105-a may configure the UE 115-a with multiple semi-persistently scheduled configurations. For example, the network entity 105-a may configure the UE 115-a with parameter sets or configurations for one or more configured grants (e.g., for uplink transmission) and parameter sets or configurations for one or more SPS configurations (e.g., for downlink transmission). A semi-persistently scheduled configuration may include one or more parameters for communicating semi-persistently scheduled signaling. For example, a semi-persistently scheduled configuration may include parameters associated with a periodicity, HARQ codebook, aggregation factor, and periodicity, among other parameters.

The network entity 105-a may activate a first semi-persistently scheduled configuration at the UE 115-a. For example, the network entity 105-a may transmit one or more control messages 205 to activate a first SPS configuration or a first configured grant, or both. In some examples, the UE 115-a may transmit semi-persistent uplink transmissions on configured grant resources 210. Additionally, or alternatively, the UE 115-a may receive semi-persistent downlink transmissions on SPS resources 215.

In an example, the UE 115-a may transmit on the configured grant resources 210 in accordance with a corresponding configured grant configuration. For example, the configured grant resources 210 may have a periodicity based on the corresponding configured grant configuration, such as a timer parameter of the corresponding configured grant configuration. Similarly, the UE 115-a may receive downlink signaling on the SPS resources 215 in accordance with a corresponding SPS configuration. For example, the SPS resources 215 may have a periodicity based on the corresponding SPS configuration, such as a timer parameter of the corresponding SPS configuration.

The wireless communications system 200 may support techniques to switch between semi-persistently scheduled configurations at a UE 115 using a single control message 205. For example, the network entity 105-a may transmit a single activation downlink control information message (e.g., of a downlink control information format for scheduling a single downlink shared channel or uplink shared channel) to dynamically switch among multiple SPS or configured grant configurations of different configuration indexes. In some examples, the multiple configurations (e.g., SPS and configured grant configurations) may be configured via higher layer signaling (e.g., RRC signaling) and associated with a HARQ identifier in the downlink control message.

For example, the network entity 105-a may transmit a control message 205-a to the UE 115-a to activate a first SPS configuration. The UE 115-a may monitor for downlink signaling on SPS resources 215-a in accordance with the first SPS configuration. The first SPS configuration may have a first set of parameters for SPS communications.

To switch SPS configurations or update parameters for an SPS configuration at the UE 115-a, the network entity 105-a may transmit a control message 205-b to the UE 115-a. The control message 205-b may configure the UE 115-a to switch from the first SPS configuration to a second SPS configuration. For example, the UE 115-a may deactivate the first SPS configuration and activate the second SPS configuration based on receiving the control message 205-b. The second SPS configuration may have different parameters for SPS communications than the first SPS configuration. In some cases, the second SPS configuration may have a different periodicity or timer value than the first SPS configuration. For example, there may be a different interval of time between occasions of the SPS resources 215-a (e.g., associated with the first SPS configuration) and occasions of SPS resources 215-b (e.g., associated with the second SPS configuration) After deactivating the first SPS configuration and activating the second SPS configuration, the UE 115-a may monitor for downlink signaling on the SPS resources 215-b in accordance with the second SPS configuration. These techniques may effectively switch an SPS configuration at the UE 115-a or update parameters for an SPS configuration at the UE 115-a with a single control message, such as a single downlink control information message.

In some examples, the network entity 105-a may configure the UE 115-a with one or more switching lists or mappings for switching between semi-persistently scheduled configurations. For example, the network entity 105-a may configure the UE 115-a with a configured grant configuration switching list or an SPS configuration switching list, or both. In some cases, a value of an identifier, such as a HARQ process identifier field in a downlink control information format, may indicate, or be mapped to, a corresponding entry for switching from a first SPS configuration or configured grant to a second SPS configuration or configured grant. For example, after receiving a downlink control information with the HARQ process identifier, the UE 115-a may deactivate the first SPS configuration or configured grant and activate the second SPS configuration or configured grant. Different indexes may be associated with, or mapped to, pairs of semi-persistent scheduling configurations, indicating to deactivate a first semi-persistent scheduling configuration of the pair and activate a second semi-persistent scheduling configuration of the pair. In some examples, the one or more switching lists or mappings may be configured via RRC signaling. In some cases, the one or more switching lists may be configured at the UE 115-a with the configurations for SPS or configured grant.

In an example, the network entity 105-a may configure the UE 115-a with a switching list for SPS configurations. A first identifier (e.g., HARQ process identifier value ‘0’) may correspond to switching from a first SPS configuration (e.g., SPS configuration ‘0’) to a second SPS configuration (e.g., SPS configuration ‘1’). When the UE 115-a receives the control message 205-b indicating the first identifier, the UE 115-a may deactivate the first SPS configuration and activate the second SPS configuration. Similarly, HARQ process identifier value ‘1’may correspond to switching from SPS configuration ‘1’ to SPS configuration ‘2’, HARQ process identifier value ‘2’ may correspond to switching from SPS configuration ‘2’ to SPS configuration 3′, and HARQ process identifier value ‘4’ may correspond to switching from SPS configuration ‘3’ to SPS configuration ‘1’. These possible mappings are exemplary, and additional or different mappings may be configured in a switching list.

In some examples, the network entity 105-a may similarly configure the UE 115-a with a switching list for configured grant configurations. For example, the network entity 105-a may transmit a control message 205 indicating a second identifier, and the UE 115-a may deactivate a first configured grant (e.g., a configured grant with index ‘1’) and enable a second configured grant (e.g., a configured grant with index ‘2’).

In some cases, the UE 115-a may be configured with separate switching lists for uplink semi-persistent scheduling configurations and downlink semi-persistent scheduling configurations. In some other examples, the UE115-a may be configured with a single list that indicates switches for both uplink semi-persistent scheduling configurations (e.g., configured grant) and downlink semi-persistent scheduling configurations (e.g., SPS). In some cases, a switching list may include a mapping of identifiers and switches between any two semi-persistent scheduling configurations. In some other examples, the switching list may include a mapping of a subset of identifier and switches between a subset of semi-persistent scheduling configurations. In some examples, a HARQ identifier may indicate only switching from a first SPS configuration to a second SPS configuration, or only switching from a first configured grant configuration to a second configured grant configuration. In some examples, a HARQ identifier may indicate both switching from a first SPS configuration to a second SPS configuration and switching from a first configured grant configuration to a second configured grant configuration. For example, a HARQ identifier may indicate to switch either an SPS configuration or a configured grant configuration or to switch both an SPS configuration and a configured grant configuration.

In some cases, the control message 205-b (e.g., the switching downlink control information message) may include an indication of parameters to be applied for the second semi-persistent scheduling configuration. For example, the control message 205-a may indicate a modulation and coding scheme (MCS), a time domain resource allocation (TDRA), a frequency domain resource allocation (FDRA), one or more transmission configuration indicator (TCI) states, or any combination thereof. The UE 115-a may apply these parameters to the second semi-persistent scheduling configuration (e.g., the semi-persistent scheduling configuration the UE 115-a switches to). These techniques may be applied for both uplink semi-persistent scheduling configurations and downlink semi-persistent scheduling configurations.

In some examples, a control message 205 may support either activation of a single semi-persistent scheduling configuration (e.g., without deactivation) or switching between semi-persistent scheduling configurations (e.g., deactivation and activation). For example, an identifier that is mapped to both a first semi-persistent scheduling configuration and a second semi-persistent scheduling configuration may indicate a switch from the first semi-persistent scheduling configuration to the second semi-persistent scheduling configuration. An identifier that is mapped to a single semi-persistent scheduling configuration may indicate to activate that semi-persistent scheduling configuration.

For example, a first identifier may be mapped to a first semi-persistent scheduling configuration. When the UE 115-a receives a control message 205 indicating the first identifier, the UE 115-a may activate the first semi-persistent scheduling configuration. A second identifier may be mapped to the first semi-persistent scheduling configuration and a second semi-persistent scheduling configuration. When the UE 115-a receives a second control message 205 indicating the second identifier, the UE 115-a may disable the first semi-persistent scheduling configuration and activate the second semi-persistent scheduling configuration. These techniques may be applied for both uplink semi-persistent scheduling configurations and downlink semi-persistent scheduling configurations.

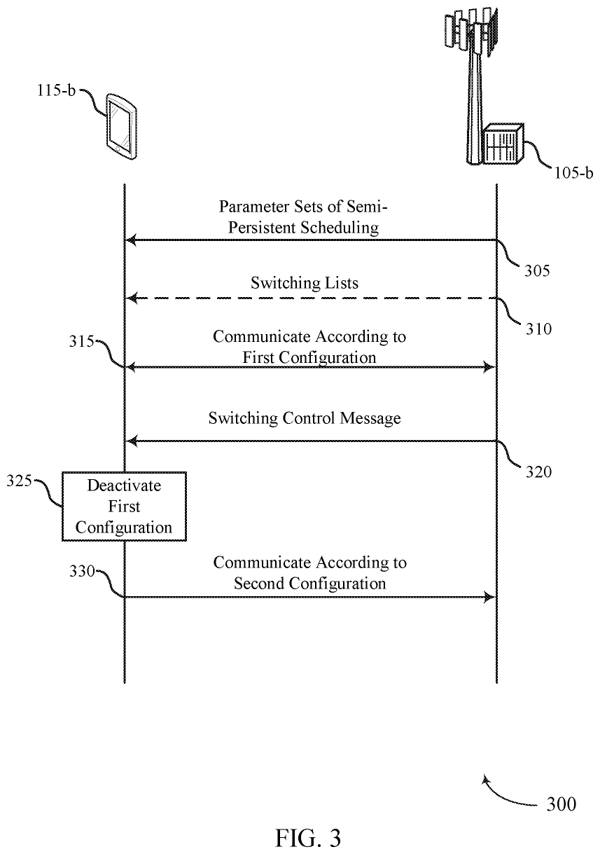

FIG. 3 illustrates an example of a process flow 300 that supports dynamic switching for semi-persistent scheduling and configured grant in accordance with one or more aspects of the present disclosure. The process flow 300 may be implemented by a UE 115-b or a network entity 105-b, or both, which may be respective examples of a UE 115 and a network entity 105 as described with reference to FIGS. 1 and 2. In some examples, some additional processes or signaling now shown by FIG. 3 may occur.

Additionally, or alternatively, some processes or signaling shown by the FIG. 3 may not occur. In some examples, some processes or signaling of the process flow 300 may occur in a different order than shown.

At 305, the network entity 105-b may transmit, and the UE 115-b may receive, a message indicating multiple parameter sets for semi-persistent scheduling.

For example, the UE 115-b may receive multiple configurations for downlink semi-persistent scheduling or multiple configurations for uplink semi-persistent scheduling (e.g., configured grant), or both.

In some examples, the UE 115-b may receive an indication of one or more switching lists for the multiple semi-persistent scheduling configurations. For example, the UE 115-b may receive an indication of an association or mapping between one or more indexes and one or more pairings of the multiple parameter sets. In an example, the network entity 105-b may transmit a switching list for the downlink semi-persistent scheduling configurations for a switching list for the uplink semi-persistent scheduling configurations, or both. In some examples, the network entity 105-b may indicate one or more switching lists with the parameter sets for the semi-persistent scheduling configurations (e.g., in a same transmission). Additionally, or alternatively, the semi-persistent scheduling configurations and the switching lists may be configured via separate signaling

In a switching list, an index or identifier, such as a HARQ process identifier, may be mapped to a pairing of semi-persistent scheduling configurations. For example, a first index may be associated with switching from a first semi-persistent scheduling configuration to a second semi-persistent scheduling configuration. Additionally, or alternatively, some indexes may be associated with activating a semi-persistent scheduling configuration (e.g., without deactivating another semi-persistent scheduling configuration). For example, a second index may be associated with a single semi-persistent scheduling configuration, and a control message indicating the second index may indicate for the UE 115-b to activate that semi-persistent scheduling configuration (e.g., without switching from or deactivating another semi-persistent scheduling configuration).

At 315, the UE 115-b and the network entity 105-b may communicate in accordance with a first parameter set of the multiple parameter sets. For example, the UE 115-b and the network entity 105-b may communicate in accordance with a first semi-persistent scheduling configuration (e.g., for uplink or downlink). The first semi-persistent scheduling configuration may be associated with, or include, a first set of parameters, such as a first timer value.

In some examples, the network entity 105-b may update, change, or switch a semi-persistent scheduling configuration at the UE 115-b. For example, traffic patterns may change such that a different semi-persistent scheduling configuration is more efficient. In some cases, the UE 115-b and the network entity 105-b may communicate XR signaling, and a different semi-persistent scheduling configuration with different parameters may be more efficient for the traffic bursts of the XR signaling. For example, the network entity 105-b may change to a semi-persistent scheduling configuration with a longer or shorter timer, or a different periodicity for transmission occasions.

The network entity 105-b may transmit, and the UE 115-b may receive, a control message indicating to deactivate the first parameter set and activate a second parameter set from the multiple parameter sets. For example, the network entity 105-b may transmit a control message, such as a downlink control information message or a switching downlink control information message, including an index that is mapped to a switch between the first semi-persistent scheduling configuration and the second semi-persistent scheduling configuration. For example, the control message may include an index, such as a HARQ process identifier, associated with switching from the first semi-persistent scheduling configuration to the second semi-persistent scheduling configuration.

In some examples, the control message may include one or more parameters for the second semi-persistent scheduling configuration. For example, the control message may include an MCS, a TDRA, an FDRA, or one or more TCI states, or any combination thereof, for the second semi-persistent scheduling configuration. In some cases, the UE 115-b may apply the one or more parameters when communicating according to the second semi-persistent scheduling configuration.

At 325, the UE 115-b may deactivate the first parameter set based on the control message. For example, the UE 115-b may deactivate the first semi-persistent scheduling configuration based on the control message indicating the switch from the first semi-persistent scheduling configuration to the second semi-persistent scheduling configuration. In some examples, the UE 115-b may activate the second semi-persistent scheduling configuration based on receiving the control message.

At 330, the UE 115-b and the network entity 105-b may communicate in accordance with the second parameter set based on the control message. For example, the UE 115-b and the network entity 105-b may communicate in accordance with the second semi-persistent scheduling configuration.

These techniques may be applied for uplink semi-persistent scheduling (e.g., configured grant) or downlink semi-persistent scheduling. For example, the control message may switch between uplink semi-persistent scheduling configurations or downlink semi-persistent scheduling configurations, or both.

For example, for uplink semi-persistent scheduling, the UE 115-b may transmit on a first set of configured grant resources according to a first configured grant configuration at 315. The UE 115-b may receive the control message at 320 and switch to a second configured grant configuration based on the control message. For example, the UE 115-b may deactivate the first configured grant configuration and activate the second configured grant configuration based on receiving the control message. At 330, the UE 115-b may transmit on a second set of configured grant resources according to the second configured grant configuration at 330.

For downlink semi-persistent scheduling, the UE 115-b may receive on a first set of SPS resources according to a first SPS configuration at 315. The UE 115-b may receive the control message at 320 and switch to a second SPS configuration based on the control message. For example, the UE 115-b may deactivate the first SPS configuration and activate the second SPS configuration based on receiving the control message. At 330, the UE 115-b may transmit on a second set of SPS resources according to the second SPS configuration at 330.

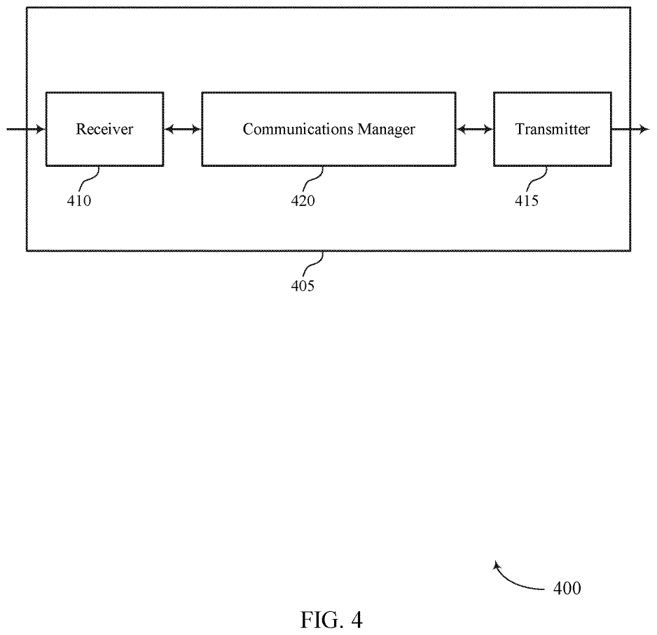

FIG. 4 shows a block diagram 400 of a device 405 that supports dynamic switching for SPS and configured grant in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to dynamic switching for SPS and configured grant). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to dynamic switching for SPS and configured grant). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of dynamic switching for SPS and configured grant as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for receiving a message indicating a set of multiple parameter sets for semi-persistent scheduling. The communications manager 420 may be configured as or otherwise support a means for communicating in accordance with a first parameter set of the set of multiple parameter sets. The communications manager 420 may be configured as or otherwise support a means for receiving a control message indicating to deactivate the first parameter set and activate a second parameter set of the set of multiple parameter sets. The communications manager 420 may be configured as or otherwise support a means for deactivating the first parameter set based on the control message. The communications manager 420 may be configured as or otherwise support a means for communicating in accordance with the second parameter set based on the control message.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced overhead by reducing a quantity of control messages used to switch semi-persistent scheduling configurations. For example, these techniques may enable a UE 115 to both deactivate a first semi-persistent scheduling configuration and activate a second semi-persistent scheduling configuration (e.g., for uplink or downlink) with a single control message.

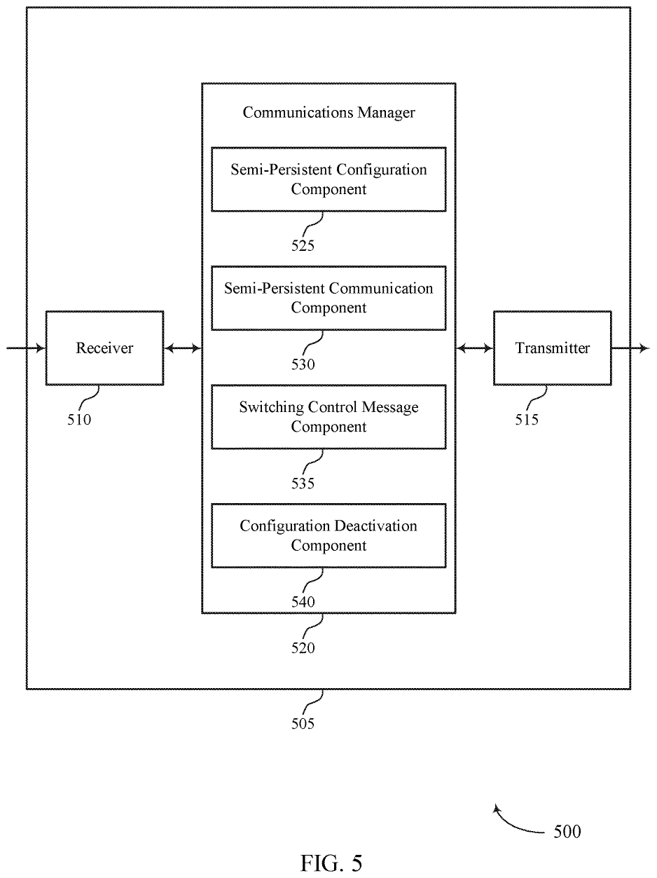

FIG. 5 shows a block diagram 500 of a device 505 that supports dynamic switching for SPS and configured grant in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to dynamic switching for SPS and configured grant). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dynamic switching for SPS and configured grant). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of dynamic switching for SPS and configured grant as described herein. For example, the communications manager 520 may include a semi-persistent configuration component 525, a semi-persistent communication component 530, a switching control message component 535, a configuration deactivation component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The semi-persistent configuration component 525 may be configured as or otherwise support a means for receiving a message indicating a set of multiple parameter sets for semi-persistent scheduling. The semi-persistent communication component 530 may be configured as or otherwise support a means for communicating in accordance with a first parameter set of the set of multiple parameter sets. The switching control message component 535 may be configured as or otherwise support a means for receiving a control message indicating to deactivate the first parameter set and activate a second parameter set of the set of multiple parameter sets. The configuration deactivation component 540 may be configured as or otherwise support a means for deactivating the first parameter set based on the control message. The semi-persistent communication component 530 may be configured as or otherwise support a means for communicating in accordance with the second parameter set based on the control message.

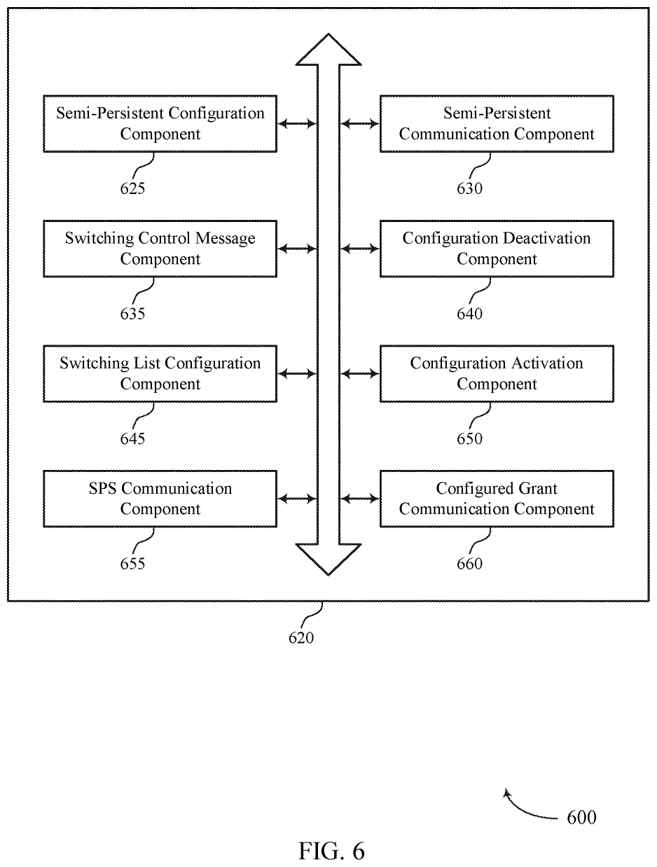

FIG. 6 shows a block diagram 600 of a communications manager 620 that supports dynamic switching for SPS and configured grant in accordance with one or more aspects of the present disclosure. The communications manager 620 may be an example of aspects of a communications manager 420, a communications manager 520, or both, as described herein. The communications manager 620, or various components thereof, may be an example of means for performing various aspects of dynamic switching for SPS and configured grant as described herein. For example, the communications manager 620 may include a semi-persistent configuration component 625, a semi-persistent communication component 630, a switching control message component 635, a configuration deactivation component 640, a switching list configuration component 645, a configuration activation component 650, an SPS communication component 655, a configured grant communication component 660, or any combination thereof. Each of these components may communicate, directly or indirectly, with one another (e.g., via one or more buses).

The communications manager 620 may support wireless communications at a UE in accordance with examples as disclosed herein. The semi-persistent configuration component 625 may be configured as or otherwise support a means for receiving a message indicating a set of multiple parameter sets for semi-persistent scheduling. The semi-persistent communication component 630 may be configured as or otherwise support a means for communicating in accordance with a first parameter set of the set of multiple parameter sets. The switching control message component 635 may be configured as or otherwise support a means for receiving a control message indicating to deactivate the first parameter set and activate a second parameter set of the set of multiple parameter sets. The configuration deactivation component 640 may be configured as or otherwise support a means for deactivating the first parameter set based on the control message. In some examples, the semi-persistent communication component 630 may be configured as or otherwise support a means for communicating in accordance with the second parameter set based on the control message.

In some examples, to support receiving the control message, the switching control message component 635 may be configured as or otherwise support a means for receiving the control message indicating one or more parameters for the second parameter set, where communicating in accordance with the second parameter set is based on the one or more parameters for the second parameter set. In some examples, the one or more parameters include a modulation and coding scheme, a time domain resource allocation, a frequency domain resource allocation, one or more transmission configuration indicator states, or any combination thereof.

In some examples, to support receiving the message, the switching list configuration component 645 may be configured as or otherwise support a means for receiving an indication of an association between one or more indexes and one or more pairings of the set of multiple parameter sets.

In some examples, the message indicates an index associated with deactivating the first parameter set and activating the second parameter set. In some examples, the message includes a second one or more indexes associated with activating a corresponding parameter set of the set of multiple parameter sets. In some examples, the one or more indexes are one or more hybrid automatic repeat request process identifiers.

In some examples, to support communicating in accordance with the second parameter set, the configuration activation component 650 may be configured as or otherwise support a means for activating the second parameter set based on the control message.

In some examples, to support receiving the message, the SPS communication component 655 may be configured as or otherwise support a means for receiving the message indicating a set of multiple downlink semi-persistent scheduling parameter sets. In some examples, to support communicating in accordance with the first parameter set, the SPS communication component 655 may be configured as or otherwise support a means for receiving on a first set of semi-persistent scheduling resources according to a first downlink semi-persistent scheduling parameter set of the set of multiple downlink semi-persistent scheduling parameter sets. In some examples, to support communicating in accordance with the second parameter set, the SPS communication component 655 may be configured as or otherwise support a means for receiving on a second set of semi-persistent scheduling resources according to a second downlink semi-persistent scheduling parameter set of the set of multiple downlink semi-persistent scheduling parameter sets.

In some examples, to support receiving the message, the configured grant communication component 660 may be configured as or otherwise support a means for receiving the message indicating a set of multiple configured grant parameter sets. In some examples, to support communicating in accordance with the first parameter set, the configured grant communication component 660 may be configured as or otherwise support a means for transmitting on a first set of configured grant resources according to a first configured grant parameter set of the set of multiple configured grant parameter sets. In some examples, to support communicating in accordance with the second parameter set, the configured grant communication component 660 may be configured as or otherwise support a means for transmitting on a second set of configured grant resources according to a second configured grant parameter set of the set of multiple configured grant parameter sets.

In some examples, to support receiving the message, the semi-persistent configuration component 625 may be configured as or otherwise support a means for receiving a radio resource control message indicating the set of multiple parameter sets for semi-persistent scheduling. In some examples, the set of multiple parameter sets for semi-persistent scheduling includes a set of multiple downlink semi-persistent scheduling parameter sets or a set of multiple configured grant parameter sets, or both.

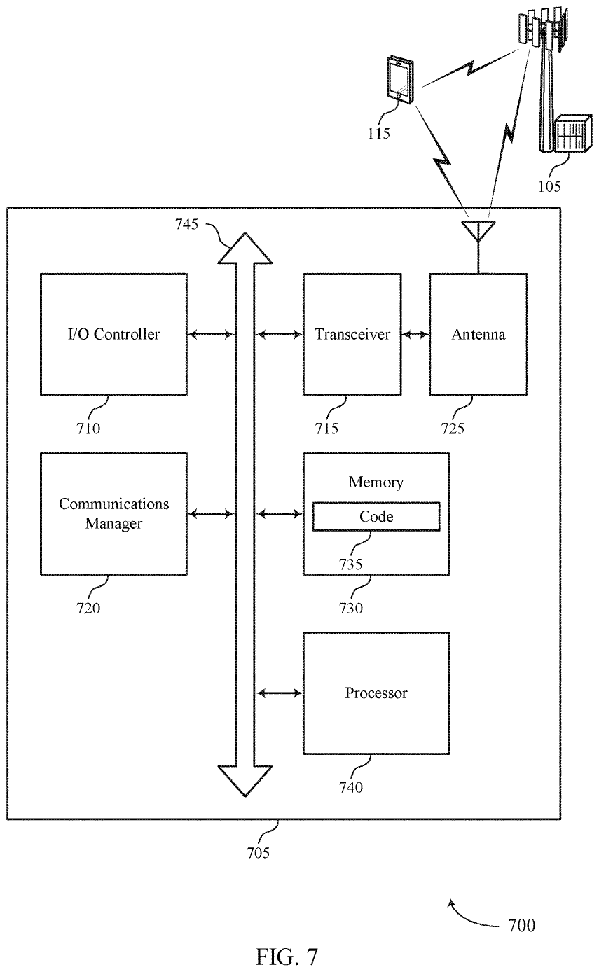

FIG. 7 shows a diagram of a system 700 including a device 705 that supports dynamic switching for SPS and configured grant in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting dynamic switching for SPS and configured grant). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving a message indicating a set of multiple parameter sets for semi-persistent scheduling. The communications manager 720 may be configured as or otherwise support a means for communicating in accordance with a first parameter set of the set of multiple parameter sets. The communications manager 720 may be configured as or otherwise support a means for receiving a control message indicating to deactivate the first parameter set and activate a second parameter set of the set of multiple parameter sets. The communications manager 720 may be configured as or otherwise support a means for deactivating the first parameter set based on the control message. The communications manager 720 may be configured as or otherwise support a means for communicating in accordance with the second parameter set based on the control message.

By including or configuring the communications manager 720 in accordance with examples as described herein, the device 705 may support techniques for reduced processing and power utilization by reducing a quantity of control messages used to switch semi-persistent scheduling configurations. For example, these techniques may enable a UE 115 to both deactivate a first semi-persistent scheduling configuration and activate a second semi-persistent scheduling configuration (e.g., for uplink or downlink) with a single control message. The device may process fewer control messages to switch the semi-persistent scheduling configurations.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of dynamic switching for SPS and configured grant as described herein, or the processor 740 and the memory 730 may be otherwise configured to perform or support such operations.

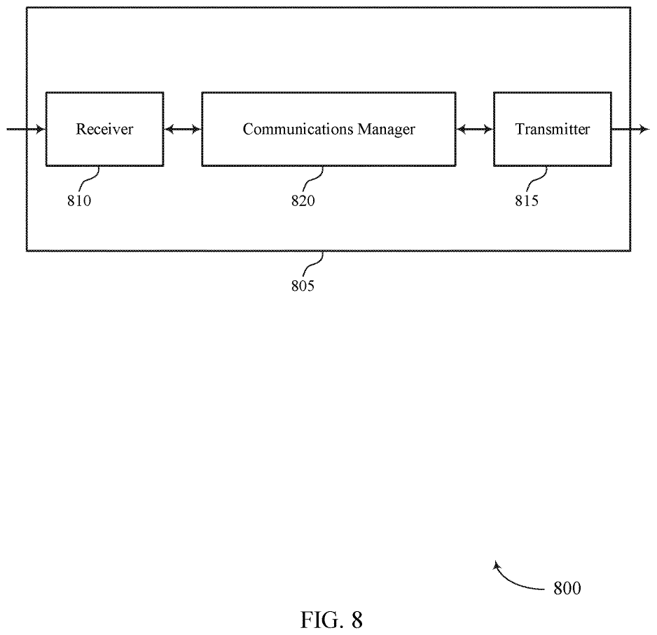

FIG. 8 shows a block diagram 800 of a device 805 that supports dynamic switching for SPS and configured grant in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of dynamic switching for SPS and configured grant as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 may be configured as or otherwise support a means for transmitting a message indicating a set of multiple parameter sets for semi-persistent scheduling. The communications manager 820 may be configured as or otherwise support a means for communicating in accordance with a first parameter set of the set of multiple parameter sets. The communications manager 820 may be configured as or otherwise support a means for transmitting a control message indicating to deactivate the first parameter set and activate a second parameter set of the set of multiple parameter sets. The communications manager 820 may be configured as or otherwise support a means for communicating in accordance with the second parameter set based on the control message.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for support techniques for reduced overhead by reducing a quantity of control messages used to switch semi-persistent scheduling configurations. For example, these techniques may enable a UE 115 to both deactivate a first semi-persistent scheduling configuration and activate a second semi-persistent scheduling configuration (e.g., for uplink or downlink) with a single control message.

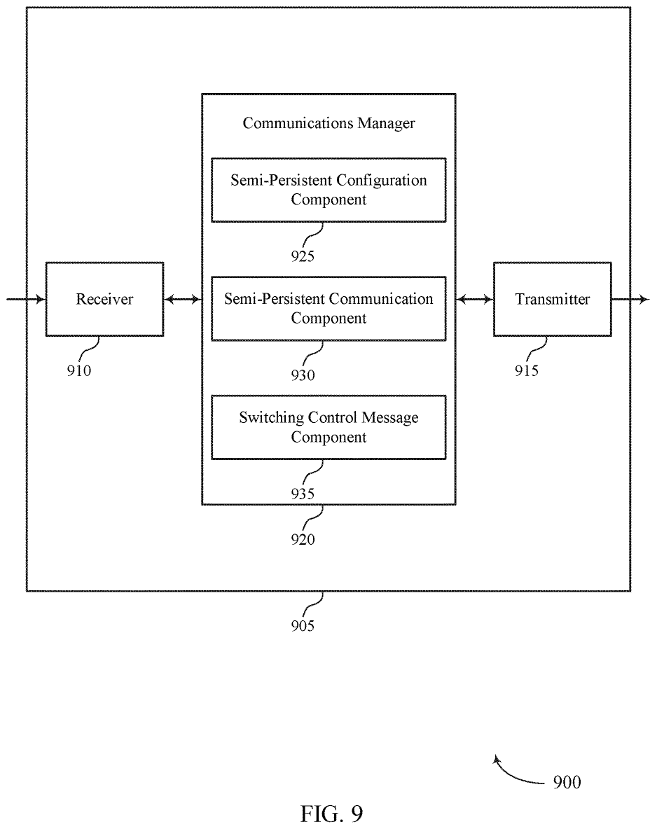

FIG. 9 shows a block diagram 900 of a device 905 that supports dynamic switching for SPS and configured grant in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of dynamic switching for SPS and configured grant as described herein. For example, the communications manager 920 may include a semi-persistent configuration component 925, a semi-persistent communication component 930, a switching control message component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The semi-persistent configuration component 925 may be configured as or otherwise support a means for transmitting a message indicating a set of multiple parameter sets for semi-persistent scheduling. The semi-persistent communication component 930 may be configured as or otherwise support a means for communicating in accordance with a first parameter set of the set of multiple parameter sets. The switching control message component 935 may be configured as or otherwise support a means for transmitting a control message indicating to deactivate the first parameter set and activate a second parameter set of the set of multiple parameter sets. The semi-persistent communication component 930 may be configured as or otherwise support a means for communicating in accordance with the second parameter set based on the control message.

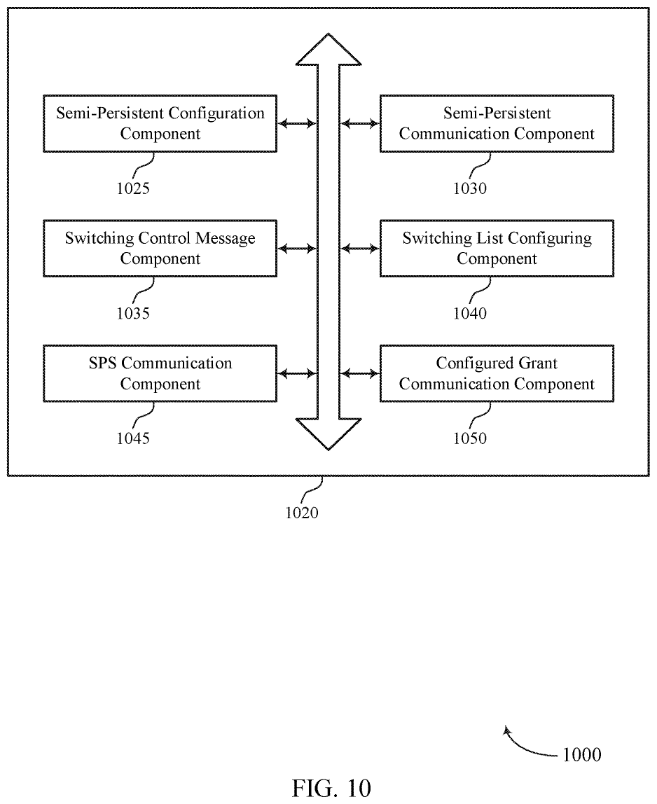

FIG. 10 shows a block diagram 1000 of a communications manager 1020 that supports dynamic switching for SPS and configured grant in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of dynamic switching for SPS and configured grant as described herein. For example, the communications manager 1020 may include a semi-persistent configuration component 1025, a semi-persistent communication component 1030, a switching control message component 1035, a switching list configuring component 1040, an SPS communication component 1045, a configured grant communication component 1050, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The semi-persistent configuration component 1025 may be configured as or otherwise support a means for transmitting a message indicating a set of multiple parameter sets for semi-persistent scheduling. The semi-persistent communication component 1030 may be configured as or otherwise support a means for communicating in accordance with a first parameter set of the set of multiple parameter sets. The switching control message component 1035 may be configured as or otherwise support a means for transmitting a control message indicating to deactivate the first parameter set and activate a second parameter set of the set of multiple parameter sets. In some examples, the semi-persistent communication component 1030 may be configured as or otherwise support a means for communicating in accordance with the second parameter set based on the control message.

In some examples, to support transmitting the control message, the switching control message component 1035 may be configured as or otherwise support a means for transmitting the control message indicating one or more parameters for the second parameter set, where communicating in accordance with the second parameter set is based on the one or more parameters for the second parameter set.

In some examples, the one or more parameters include a modulation and coding scheme, a time domain resource allocation, a frequency domain resource allocation, one or more transmission configuration indicator states, or any combination thereof.

In some examples, to support transmitting the message, the switching list configuring component 1040 may be configured as or otherwise support a means for transmitting an indication of an association between one or more indexes and one or more pairings of the set of multiple parameter sets.

In some examples, the message indicates an index associated with deactivating the first parameter set and activating the second parameter set. In some examples, the message includes a second one or more indexes associated with activating a corresponding parameter set of the set of multiple parameter sets. In some examples, the one or more indexes are one or more hybrid automatic repeat request process identifiers.

In some examples, to support transmitting the message, the SPS communication component 1045 may be configured as or otherwise support a means for transmitting the message indicating a set of multiple downlink semi-persistent scheduling parameter sets. In some examples, to support communicating in accordance with the first parameter set, the SPS communication component 1045 may be configured as or otherwise support a means for transmitting on a first set of semi-persistent scheduling resources according to a first downlink semi-persistent scheduling parameter set of the set of multiple downlink semi-persistent scheduling parameter sets. In some examples, to support communicating in accordance with the second parameter set, the SPS communication component 1045 may be configured as or otherwise support a means for transmitting on a second set of semi-persistent scheduling resources according to a second downlink semi-persistent scheduling parameter set of the set of multiple downlink semi-persistent scheduling parameter sets.

In some examples, to support transmitting the message, the configured grant communication component 1050 may be configured as or otherwise support a means for transmitting the message indicating a set of multiple configured grant parameter sets. In some examples, to support communicating in accordance with the first parameter set, the configured grant communication component 1050 may be configured as or otherwise support a means for receiving on a first set of configured grant resources according to a first configured grant parameter set of the set of multiple configured grant parameter sets. In some examples, to support communicating in accordance with the second parameter set, the configured grant communication component 1050 may be configured as or otherwise support a means for receiving on a second set of configured grant resources according to a second configured grant parameter set of the set of multiple configured grant parameter sets.

In some examples, to support transmitting the message, the semi-persistent configuration component 1025 may be configured as or otherwise support a means for transmitting a radio resource control message indicating the set of multiple parameter sets for semi-persistent scheduling. In some examples, the set of multiple parameter sets for semi-persistent scheduling includes a set of multiple downlink semi-persistent scheduling parameter sets or a set of multiple configured grant parameter sets, or both.

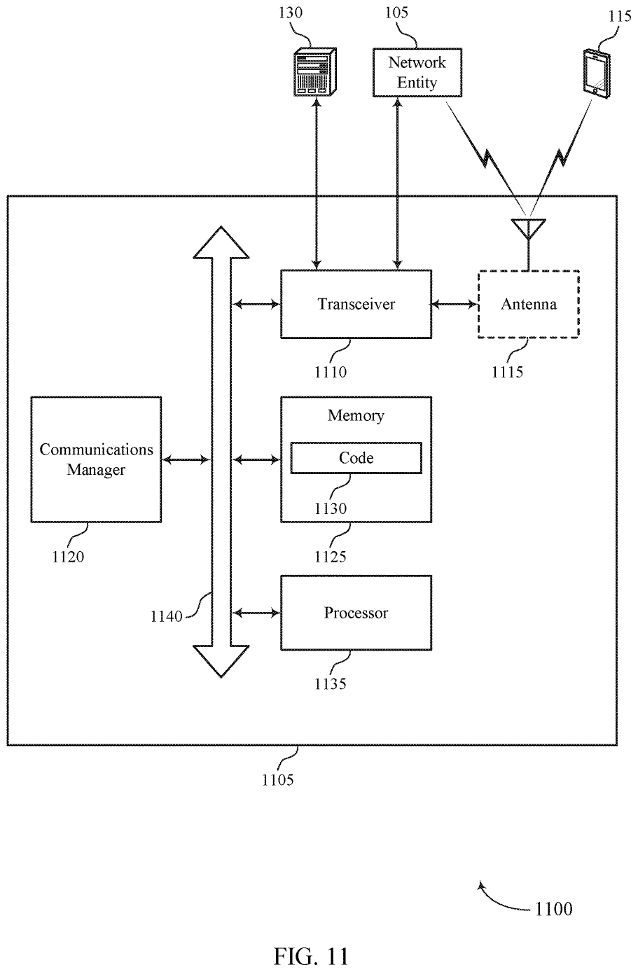

FIG. 11 shows a diagram of a system 1100 including a device 1105 that supports dynamic switching for SPS and configured grant in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting dynamic switching for SPS and configured grant). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 may be configured as or otherwise support a means for transmitting a message indicating a set of multiple parameter sets for semi-persistent scheduling. The communications manager 1120 may be configured as or otherwise support a means for communicating in accordance with a first parameter set of the set of multiple parameter sets. The communications manager 1120 may be configured as or otherwise support a means for transmitting a control message indicating to deactivate the first parameter set and activate a second parameter set of the set of multiple parameter sets. The communications manager 1120 may be configured as or otherwise support a means for communicating in accordance with the second parameter set based on the control message.

By including or configuring the communications manager 1120 in accordance with examples as described herein, the device 1105 may support techniques for reduced processing by reducing a quantity of control messages used to switch semi-persistent scheduling configurations. For example, these techniques may enable a UE 115 to both deactivate a first semi-persistent scheduling configuration and activate a second semi-persistent scheduling configuration (e.g., for uplink or downlink) with a single control message. The device 1105 may generate and transmit fewer control messages to switch semi-persistent scheduling configurations at the UE 115.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of dynamic switching for SPS and configured grant as described herein, or the processor 1135 and the memory 1125 may be otherwise configured to perform or support such operations.

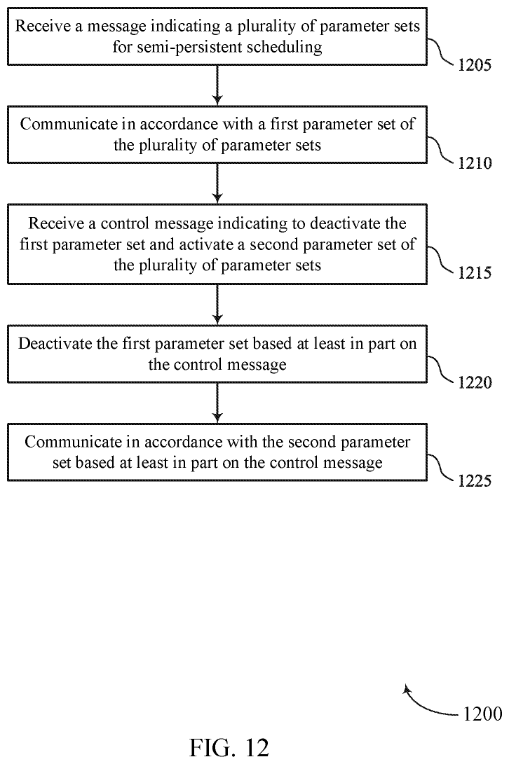

FIG. 12 shows a flowchart illustrating a method 1200 that supports dynamic switching for SPS and configured grant in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a message indicating a set of multiple parameter sets for semi-persistent scheduling. The operations of 1205 may be performed in accordance with examples as disclosed herein. In some examples, aspects of the operations of 1205 may be performed by a semi-persistent configuration component 625 as described with reference to FIG. 6.

At 1210, the method may include communicating in accordance with a first parameter set of the set of multiple parameter sets. The operations of 1210 may be performed in accordance with examples as disclosed herein. In some examples, aspects of the operations of 1210 may be performed by a semi-persistent communication component 630 as described with reference to FIG. 6.

At 1215, the method may include receiving a control message indicating to deactivate the first parameter set and activate a second parameter set of the set of multiple parameter sets. The operations of 1215 may be performed in accordance with examples as disclosed herein. In some examples, aspects of the operations of 1215 may be performed by a switching control message component 635 as described with reference to FIG. 6.

At 1220, the method may include deactivating the first parameter set based on the control message. The operations of 1220 may be performed in accordance with examples as disclosed herein. In some examples, aspects of the operations of 1220 may be performed by a configuration deactivation component 640 as described with reference to FIG. 6.

At 1225, the method may include communicating in accordance with the second parameter set based on the control message. The operations of 1225 may be performed in accordance with examples as disclosed herein. In some examples, aspects of the operations of 1225 may be performed by a semi-persistent communication component 630 as described with reference to FIG. 6.

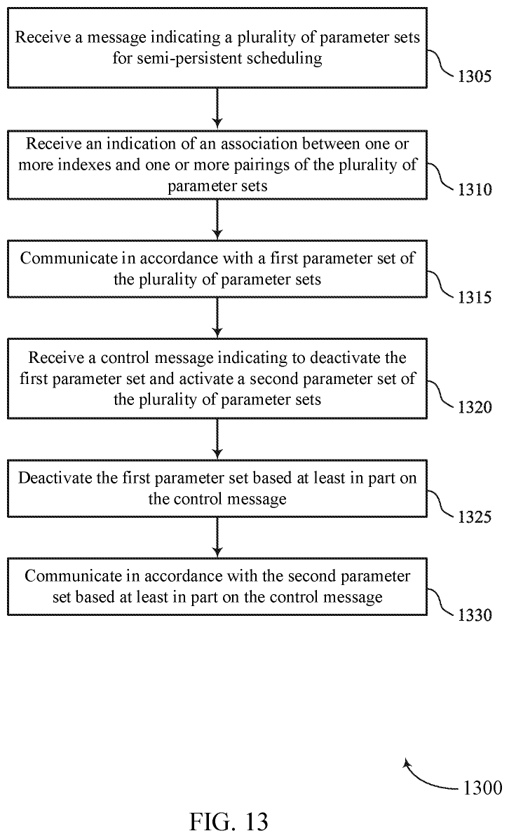

FIG. 13 shows a flowchart illustrating a method 1300 that supports dynamic switching for SPS and configured grant in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a message indicating a set of multiple parameter sets for semi-persistent scheduling. The operations of 1305 may be performed in accordance with examples as disclosed herein. In some examples, aspects of the operations of 1305 may be performed by a semi-persistent configuration component 625 as described with reference to FIG. 6.

At 1310, the method may include receiving an indication of an association between one or more indexes and one or more pairings of the set of multiple parameter sets. The operations of 1310 may be performed in accordance with examples as disclosed herein. In some examples, aspects of the operations of 1310 may be performed by a switching list configuration component 645 as described with reference to FIG. 6.

At 1315, the method may include communicating in accordance with a first parameter set of the set of multiple parameter sets. The operations of 1315 may be performed in accordance with examples as disclosed herein. In some examples, aspects of the operations of 1315 may be performed by a semi-persistent communication component 630 as described with reference to FIG. 6.

At 1320, the method may include receiving a control message indicating to deactivate the first parameter set and activate a second parameter set of the set of multiple parameter sets. The operations of 1320 may be performed in accordance with examples as disclosed herein. In some examples, aspects of the operations of 1320 may be performed by a switching control message component 635 as described with reference to FIG. 6.

At 1325, the method may include deactivating the first parameter set based on the control message. The operations of 1325 may be performed in accordance with examples as disclosed herein. In some examples, aspects of the operations of 1325 may be performed by a configuration deactivation component 640 as described with reference to FIG. 6.

At 1330, the method may include communicating in accordance with the second parameter set based on the control message. The operations of 1330 may be performed in accordance with examples as disclosed herein. In some examples, aspects of the operations of 1330 may be performed by a semi-persistent communication component 630 as described with reference to FIG. 6.

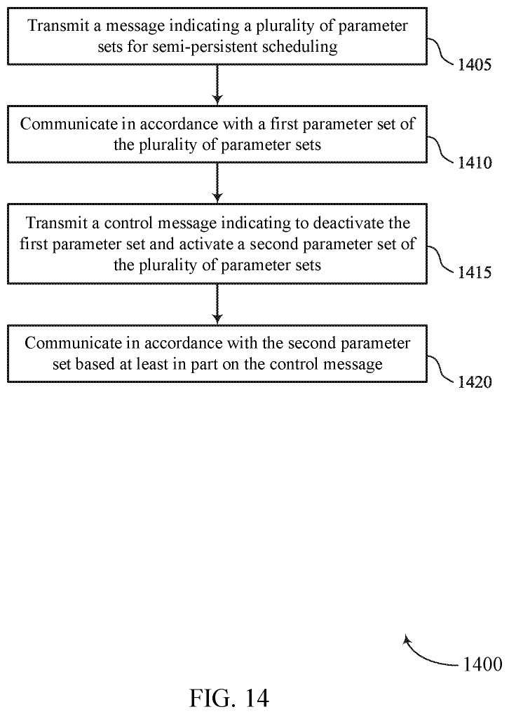

FIG. 14 shows a flowchart illustrating a method 1400 that supports dynamic switching for SPS and configured grant in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a message indicating a set of multiple parameter sets for semi-persistent scheduling. The operations of 1405 may be performed in accordance with examples as disclosed herein. In some examples, aspects of the operations of 1405 may be performed by a semi-persistent configuration component 1025 as described with reference to FIG. 10.

At 1410, the method may include communicating in accordance with a first parameter set of the set of multiple parameter sets. The operations of 1410 may be performed in accordance with examples as disclosed herein. In some examples, aspects of the operations of 1410 may be performed by a semi-persistent communication component 1030 as described with reference to FIG. 10.

At 1415, the method may include transmitting a control message indicating to deactivate the first parameter set and activate a second parameter set of the set of multiple parameter sets. The operations of 1415 may be performed in accordance with examples as disclosed herein. In some examples, aspects of the operations of 1415 may be performed by a switching control message component 1035 as described with reference to FIG. 10.

At 1420, the method may include communicating in accordance with the second parameter set based on the control message. The operations of 1420 may be performed in accordance with examples as disclosed herein. In some examples, aspects of the operations of 1420 may be performed by a semi-persistent communication component 1030 as described with reference to FIG. 10.

The following provides an overview of aspects of the present disclosure:

Aspect 1: A method for wireless communications at a UE, comprising: receiving a message indicating a plurality of parameter sets for semi-persistent scheduling; communicating in accordance with a first parameter set of the plurality of parameter sets; receiving a control message indicating to deactivate the first parameter set and activate a second parameter set of the plurality of parameter sets; deactivating the first parameter set based at least in part on the control message; and communicating in accordance with the second parameter set based at least in part on the control message.

Aspect 2: The method of aspect 1, wherein receiving the control message comprises: receiving the control message indicating one or more parameters for the second parameter set, wherein communicating in accordance with the second parameter set is based at least in part on the one or more parameters for the second parameter set.

Aspect 3: The method of aspect 2, wherein the one or more parameters include a modulation and coding scheme, a time domain resource allocation, a frequency domain resource allocation, one or more transmission configuration indicator states, or any combination thereof.

Aspect 4: The method of any of aspects 1 through 3, wherein receiving the message comprises: receiving an indication of an association between one or more indexes and one or more pairings of the plurality of parameter sets.

Aspect 5: The method of aspect 4, wherein the message indicates an index associated with deactivating the first parameter set and activating the second parameter set.

Aspect 6: The method of any of aspects 4 through 5, wherein the message includes a second one or more indexes associated with activating a corresponding parameter set of the plurality of parameter sets.

Aspect 7: The method of any of aspects 4 through 6, wherein the one or more indexes are one or more hybrid automatic repeat request process identifiers.

Aspect 8: The method of any of aspects 1 through 7, wherein communicating in accordance with the second parameter set comprises: activating the second parameter set based at least in part on the control message.

Aspect 9: The method of any of aspects 1 through 8, wherein receiving the message comprises: receiving the message indicating a plurality of downlink semi-persistent scheduling parameter sets, wherein communicating in accordance with the first parameter set includes: receiving on a first set of semi-persistent scheduling resources according to a first downlink semi-persistent scheduling parameter set of the plurality of downlink semi-persistent scheduling parameter sets; and wherein communicating in accordance with the second parameter set comprises: receiving on a second set of semi-persistent scheduling resources according to a second downlink semi-persistent scheduling parameter set of the plurality of downlink semi-persistent scheduling parameter sets.

Aspect 10: The method of any of aspects 1 through 9, wherein receiving the message comprises: receiving the message indicating a plurality of configured grant parameter sets, wherein communicating in accordance with the first parameter set comprises: transmitting on a first set of configured grant resources according to a first configured grant parameter set of the plurality of configured grant parameter sets; and wherein communicating in accordance with the second parameter set comprises: transmitting on a second set of configured grant resources according to a second configured grant parameter set of the plurality of configured grant parameter sets.

Aspect 11: The method of any of aspects 1 through 10, wherein receiving the message comprises: receiving a radio resource control message indicating the plurality of parameter sets for semi-persistent scheduling.

Aspect 12: The method of any of aspects 1 through 11, wherein the plurality of parameter sets for semi-persistent scheduling includes a plurality of downlink semi-persistent scheduling parameter sets or a plurality of configured grant parameter sets, or both.

Aspect 13: A method for wireless communications at a network entity, comprising: transmitting a message indicating a plurality of parameter sets for semi-persistent scheduling; communicating in accordance with a first parameter set of the plurality of parameter sets; transmitting a control message indicating to deactivate the first parameter set and activate a second parameter set of the plurality of parameter sets; and communicating in accordance with the second parameter set based at least in part on the control message.

Aspect 14: The method of aspect 13, wherein transmitting the control message comprises: transmitting the control message indicating one or more parameters for the second parameter set, wherein communicating in accordance with the second parameter set is based at least in part on the one or more parameters for the second parameter set.

Aspect 15: The method of aspect 14, wherein the one or more parameters include a modulation and coding scheme, a time domain resource allocation, a frequency domain resource allocation, one or more transmission configuration indicator states, or any combination thereof.

Aspect 16: The method of any of aspects 13 through 15, wherein transmitting the message comprises: transmitting an indication of an association between one or more indexes and one or more pairings of the plurality of parameter sets.

Aspect 17: The method of aspect 16, wherein the message indicates an index associated with deactivating the first parameter set and activating the second parameter set.

Aspect 18: The method of any of aspects 16 through 17, wherein the message includes a second one or more indexes associated with activating a corresponding parameter set of the plurality of parameter sets.

Aspect 19: The method of any of aspects 16 through 18, wherein the one or more indexes are one or more hybrid automatic repeat request process identifiers.

Aspect 20: The method of any of aspects 13 through 19, wherein transmitting the message comprises: transmitting the message indicating a plurality of downlink semi-persistent scheduling parameter sets, wherein communicating in accordance with the first parameter set comprises: transmitting on a first set of semi-persistent scheduling resources according to a first downlink semi-persistent scheduling parameter set of the plurality of downlink semi-persistent scheduling parameter sets; and wherein communicating in accordance with the second parameter set comprises: transmitting on a second set of semi-persistent scheduling resources according to a second downlink semi-persistent scheduling parameter set of the plurality of downlink semi-persistent scheduling parameter sets.

Aspect 21: The method of any of aspects 13 through 20, wherein transmitting the message comprises: transmitting the message indicating a plurality of configured grant parameter sets, wherein communicating in accordance with the first parameter set comprises: receiving on a first set of configured grant resources according to a first configured grant parameter set of the plurality of configured grant parameter sets; and wherein communicating in accordance with the second parameter set comprises: receiving on a second set of configured grant resources according to a second configured grant parameter set of the plurality of configured grant parameter sets.

Aspect 22: The method of any of aspects 13 through 21, wherein transmitting the message comprises: transmitting a radio resource control message indicating the plurality of parameter sets for semi-persistent scheduling.

Aspect 23: The method of any of aspects 13 through 22, wherein the plurality of parameter sets for semi-persistent scheduling includes a plurality of downlink semi-persistent scheduling parameter sets or a plurality of configured grant parameter sets, or both.

Aspect 24: An apparatus for wireless communications at a UE, comprising a processor; memory coupled with the processor; and instructions stored in the memory and executable by the processor to cause the apparatus to perform a method of any of aspects 1 through 12.

Aspect 25: An apparatus for wireless communications at a UE, comprising at least one means for performing a method of any of aspects 1 through 12.

Aspect 26: A non-transitory computer-readable medium storing code for wireless communications at a UE, the code comprising instructions executable by a processor to perform a method of any of aspects 1 through 12.

Aspect 27: An apparatus for wireless communications at a network entity, comprising a processor; memory coupled with the processor; and instructions stored in the memory and executable by the processor to cause the apparatus to perform a method of any of aspects 13 through 23.

Aspect 28: An apparatus for wireless communications at a network entity, comprising at least one means for performing a method of any of aspects 13 through 23.

Aspect 29: A non-transitory computer-readable medium storing code for wireless communications at a network entity, the code comprising instructions executable by a processor to perform a method of any of aspects 13 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a message indicating a plurality of parameter sets for semi-persistent scheduling;
communicate in accordance with a first parameter set of the plurality of parameter sets;
receive a control message indicating to deactivate the first parameter set and activate a second parameter set of the plurality of parameter sets;
deactivate the first parameter set based at least in part on the control message; and
communicate in accordance with the second parameter set based at least in part on the control message.

2. The apparatus of claim 1, wherein the instructions to receive the control message are executable by the processor to cause the apparatus to:
receive the control message indicating one or more parameters for the second parameter set, wherein communicating in accordance with the second parameter set is based at least in part on the one or more parameters for the second parameter set.

3. The apparatus of claim 2, wherein the one or more parameters include a modulation and coding scheme, a time domain resource allocation, a frequency domain resource allocation, one or more transmission configuration indicator states, or any combination thereof.

4. The apparatus of claim 1, wherein the instructions to receive the message are executable by the processor to cause the apparatus to:
receive an indication of an association between one or more indexes and one or more pairings of the plurality of parameter sets.

5. The apparatus of claim 4, wherein the message indicates an index associated with deactivating the first parameter set and activating the second parameter set.

6. The apparatus of claim 4, wherein the message includes a second one or more indexes associated with activating a corresponding parameter set of the plurality of parameter sets.

7. The apparatus of claim 4, wherein:
the one or more indexes are one or more hybrid automatic repeat request process identifiers.

8. The apparatus of claim 1, wherein the instructions to communicate in accordance with the second parameter set are executable by the processor to cause the apparatus to:
activate the second parameter set based at least in part on the control message.

9. The apparatus of claim 1, wherein the instructions to receive the message are executable by the processor to cause the apparatus to:
receive the message indicating a plurality of downlink semi-persistent scheduling parameter sets, wherein the instructions to communicate in accordance with the first parameter set are executable by the processor to cause the apparatus to:
receive on a first set of semi-persistent scheduling resources according to a first downlink semi-persistent scheduling parameter set of the plurality of downlink semi-persistent scheduling parameter sets; and wherein the instructions to communicate in accordance with the second parameter set are executable by the processor to cause the apparatus to:
receive on a second set of semi-persistent scheduling resources according to a second downlink semi-persistent scheduling parameter set of the plurality of downlink semi-persistent scheduling parameter sets.

10. The apparatus of claim 1, wherein the instructions to receive the message are executable by the processor to cause the apparatus to:
receive the message indicating a plurality of configured grant parameter sets, wherein the instructions to communicate in accordance with the first parameter set are executable by the processor to cause the apparatus to:
transmit on a first set of configured grant resources according to a first configured grant parameter set of the plurality of configured grant parameter sets; and
wherein the instructions to communicate in accordance with the second parameter set are executable by the processor to cause the apparatus to:
transmit on a second set of configured grant resources according to a second configured grant parameter set of the plurality of configured grant parameter sets.

11. The apparatus of claim 1, wherein the instructions to receive the message are executable by the processor to cause the apparatus to:
receive a radio resource control message indicating the plurality of parameter sets for semi-persistent scheduling.

12. The apparatus of claim 1, wherein the plurality of parameter sets for semi-persistent scheduling includes a plurality of downlink semi-persistent scheduling parameter sets or a plurality of configured grant parameter sets, or both.

13. An apparatus for wireless communications at a network entity, comprising:
a processor;
memory coupled with the processor; and
instructions stored in the memory and executable by the processor to cause the apparatus to:
transmit a message indicating a plurality of parameter sets for semi-persistent scheduling;
communicate in accordance with a first parameter set of the plurality of parameter sets;
transmit a control message indicating to deactivate the first parameter set and activate a second parameter set of the plurality of parameter sets; and
communicate in accordance with the second parameter set based at least in part on the control message.

14. The apparatus of claim 13, wherein the instructions to transmit the control message are executable by the processor to cause the apparatus to:
transmit the control message indicating one or more parameters for the second parameter set, wherein communicating in accordance with the second parameter set is based at least in part on the one or more parameters for the second parameter set.

15. The apparatus of claim 14, wherein the one or more parameters include a modulation and coding scheme, a time domain resource allocation, a frequency domain resource allocation, one or more transmission configuration indicator states, or any combination thereof.

16. The apparatus of claim 13, wherein the instructions to transmit the message are executable by the processor to cause the apparatus to:
transmit an indication of an association between one or more indexes and one or more pairings of the plurality of parameter sets.

17. The apparatus of claim 16, wherein the message indicates an index associated with deactivating the first parameter set and activating the second parameter set.

18. The apparatus of claim 16, wherein the message includes a second one or more indexes associated with activating a corresponding parameter set of the plurality of parameter sets.

19. The apparatus of claim 16, wherein:
the one or more indexes are one or more hybrid automatic repeat request process identifiers.

20. The apparatus of claim 13, wherein the instructions to transmit the message are executable by the processor to cause the apparatus to:
transmit the message indicating a plurality of downlink semi-persistent scheduling parameter sets, wherein the instructions to communicate in accordance with the first parameter set are executable by the processor to cause the apparatus to:
transmit on a first set of semi-persistent scheduling resources according to a first downlink semi-persistent scheduling parameter set of the plurality of downlink semi-persistent scheduling parameter sets; and wherein the instructions to communicate in accordance with the second parameter set are executable by the processor to cause the apparatus to:
transmit on a second set of semi-persistent scheduling resources according to a second downlink semi-persistent scheduling parameter set of the plurality of downlink semi-persistent scheduling parameter sets.

21. The apparatus of claim 13, wherein the instructions to transmit the message are executable by the processor to cause the apparatus to:
transmit the message indicating a plurality of configured grant parameter sets, wherein communicating in accordance with the first parameter set comprises:
receive on a first set of configured grant resources according to a first configured grant parameter set of the plurality of configured grant parameter sets; and
wherein communicating in accordance with the second parameter set comprises:
receive on a second set of configured grant resources according to a second configured grant parameter set of the plurality of configured grant parameter sets.

22. The apparatus of claim 13, wherein the instructions to transmit the message are executable by the processor to cause the apparatus to:
transmit a radio resource control message indicating the plurality of parameter sets for semi-persistent scheduling.

23. The apparatus of claim 13, wherein the plurality of parameter sets for semi-persistent scheduling includes a plurality of downlink semi-persistent scheduling parameter sets or a plurality of configured grant parameter sets, or both.

24. A method for wireless communications at a user equipment (UE), comprising:
receiving a message indicating a plurality of parameter sets for semi-persistent scheduling;
communicating in accordance with a first parameter set of the plurality of parameter sets;
receiving a control message indicating to deactivate the first parameter set and activate a second parameter set of the plurality of parameter sets;
deactivating the first parameter set based at least in part on the control message; and
communicating in accordance with the second parameter set based at least in part on the control message.

25. The method of claim 24, wherein receiving the control message comprises:
receiving the control message indicating one or more parameters for the second parameter set, wherein communicating in accordance with the second parameter set is based at least in part on the one or more parameters for the second parameter set.

26. The method of claim 25, wherein the one or more parameters include a modulation and coding scheme, a time domain resource allocation, a frequency domain resource allocation, one or more transmission configuration indicator states, or any combination thereof.

27. The method of claim 24, wherein receiving the message comprises:
receiving an indication of an association between one or more indexes and one or more pairings of the plurality of parameter sets.

28. The method of claim 27, wherein the message indicates an index associated with deactivating the first parameter set and activating the second parameter set.

29. The method of claim 27, wherein the message includes a second one or more indexes associated with activating a corresponding parameter set of the plurality of parameter sets.

30. A method for wireless communications at a network entity, comprising:
transmitting a message indicating a plurality of parameter sets for semi-persistent scheduling;
communicating in accordance with a first parameter set of the plurality of parameter sets;
transmitting a control message indicating to deactivate the first parameter set and activate a second parameter set of the plurality of parameter sets; and
communicating in accordance with the second parameter set based at least in part on the control message.
